(19) United States
(12) Patent Application Publication
(10) Pub. No.: US 2005/0105894 A1
(43) Pub. Date: May 19, 2005

(54) Information storage medium, and apparatus and method of reproducing information from the same

(75) Inventors: Kil-soo Jung, Hwaseong-si (KR); Seong-Jin Moon, Suwon-Si (KR); Sung-wook Park, Seoul (KR); Hyun-kwon Chung, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/900,390

(22) Filed: Jul. 28, 2004

Related U.S. Application Data
(60) Provisional application No. 60/492,330, filed on Aug. 5, 2003.

(30) Foreign Application Priority Data
Sep. 9, 2003 (KR) 2003-63406

(51) Int. Cl. H04N 5/781

(52) U.S. Cl. 386/96; 386/125

(57) ABSTRACT

An information storage medium and method allowing video object data to be reproduced with corresponding audio data obtained from a source external of the information storage medium, the apparatus includes a reader reading video object data from an information storage medium, audio data from the source external of the information storage medium, and audio mapping data; a mapping processor processing mapping data regarding a mapping relationship between the video object data and the audio data, and providing a relationship between the audio data and the video object data, the mapping data being included in the audio mapping data; a decoder decoding the video object data and the audio data; and a data output unit outputting the decoded video object data with the decoded audio data corresponding to the video object data, based on the audio mapping data.

### CROSS-REFERENCE TO RELATED APPLICATIONS

This application claims the priorities of U.S. Provisional Patent Application No. 60/492,330, filed on Aug. 5, 2003, in the USPTO, and Korean Patent Application No. 2003-63406, filed on Sep. 9, 2003, in the Korean Intellectual Property Office, the disclosures of which are incorporated herein by reference.

### BACKGROUND OF THE INVENTION

1. Field of the Invention

The present invention relates to an information storage medium that allows audio data obtained from a source external of the information storage medium, such as, via the Internet to be reproduced with corresponding video object data, and an apparatus and method of reproducing the audio data with the video object data.

2. Description of the Related Art

Video object data and audio data are stored together in a conventional information storage medium such as a Digital Versatile Disc (DVD), so that the video object data can be reproduced together with the audio data. However, the audio data stored with the video object data cannot be replaced with another audio data.

FIG. 1 is a conceptual diagram illustrating a unit of video object data linked to a plurality of audio data, stored in a DVD. In order to reproduce the video object data generated and stored in a plurality of languages such as English, Korean, and Spanish, the video object data must be stored with the audio data in the plurality of languages in an information storage medium. There is a case where after manufacturing and selling an information storage medium storing the video object data, the video object data must be reproduced with audio data in a different language from the original language of the audio data recorded in the information storage medium. Also, there is a case where a director's commentary audio containing comments by a movie manufacturer, a movie director, and a movie photographer are separately provided to those who purchase the information storage medium containing the video object data.

However, in these cases, it is difficult to reproduce and associate the video object data stored in the information storage medium with the audio data stored outside the information storage medium.

### SUMMARY OF THE INVENTION

According to an aspect of the present invention, there is provided an information storage medium that allows video object data to be reproduced together with corresponding audio data obtained from a source external of the information storage medium such as via the Internet.

According to another aspect of the present invention, there is provided an apparatus and method of reproducing video object data stored in an information storage medium, with corresponding audio data obtained from a source external of the information storage medium such as via the Internet.

According to one aspect of the present invention, there is provided an information storage medium including video object data; and audio mapping data specifying a mapping relation between the video object data and audio data obtained via the Internet, wherein the audio data is reproduced together with a corresponding part of the video object data based on the audio mapping data.

According to another aspect of the present invention, there is provided a reproducing apparatus including a reader reading video object data from an information storage medium, audio data via the Internet, and audio mapping data; a mapping processor processing information regarding a mapping relationship between the video object data and the audio data, and providing a relationship between the audio data and the video object data based on a result of the processing, the information being included in the audio mapping data; a decoder decoding the video object data and the audio data; and a data output unit outputting the decoded video object data with the decoded corresponding audio data, based on the audio mapping data.

According to yet another aspect of the present invention, there is provided a method of reproducing information, the method including reading video object data from an information storage medium, reading audio mapping data that specifies a mapping relationship between the video object data and audio data obtained via the Internet, reading the audio data mapped to the video object data via the Internet, based on the audio mapping data, and reproducing the video object data with corresponding audio data based on the audio mapping data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a unit of video object data linked to a plurality of audio data, stored in a Digital Versatile Disc (DVD);

FIG. 2 is a schematic block diagram of a reproducing apparatus according to an embodiment of the present invention;

FIG. 3 is a block diagram of the reproducing apparatus of FIG. 2;

FIG. 4 illustrates a logical structure of a DVD directory;

FIG. 5 illustrates a logical structure of a video object set;

FIG. 6 illustrates structures of Video ManaGer Information (VMGI) and Video Title Set Information (VTSI);

FIG. 7 is a diagram of Internet audio streaming;

FIG. 8 is a flowchart illustrating a method of reproducing information according to an embodiment of the present invention;

FIG. 9 is a flowchart illustrating a method of reading audio mapping data via the Internet according to an embodiment of the present invention;

FIG. 10 is a flowchart illustrating a method of reading audio mapping data via the Internet by executing a command stored in an information storage medium, according to an embodiment of the present invention;

FIG. 11 is a diagram of a structure of audio mapping data according to an embodiment of the present invention;

FIG. 12 illustrates a structure of video object data stored in units of video clips;

FIG. 13 is a diagram illustrating a method of selecting audio data from an audio list according to a language or an application of audio data and reproducing the selected audio data with related video object data, according to an embodiment of the present invention;

FIG. 14 illustrates a structure of information listed in an audio list that allows a user to select audio data in a desired language, according to an embodiment of the present invention; and

FIG. 15 illustrates a structure of information listed in an audio list that allows a user to select audio data of a desired application, according to another embodiment of the present invention.

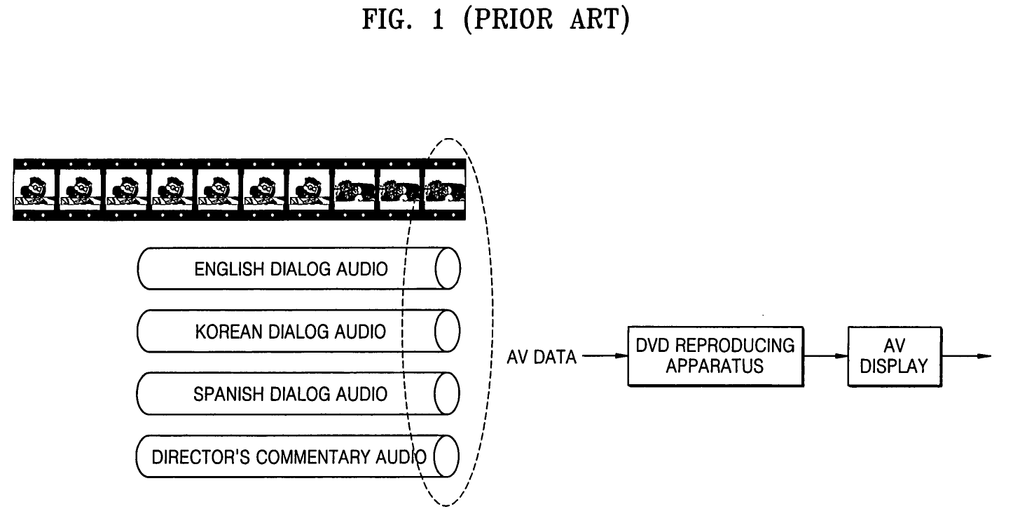

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A conventional information storage medium such as a Digital Versatile Disc (DVD) does not allow video data stored therein to be reproduced together with audio data that is not stored in the information storage medium. To solve this and/or other problems, the present invention suggests an information storage medium allowing video data stored therein to be reproduced together with corresponding audio data that is not stored in the information storage medium, and an apparatus and method therefor.

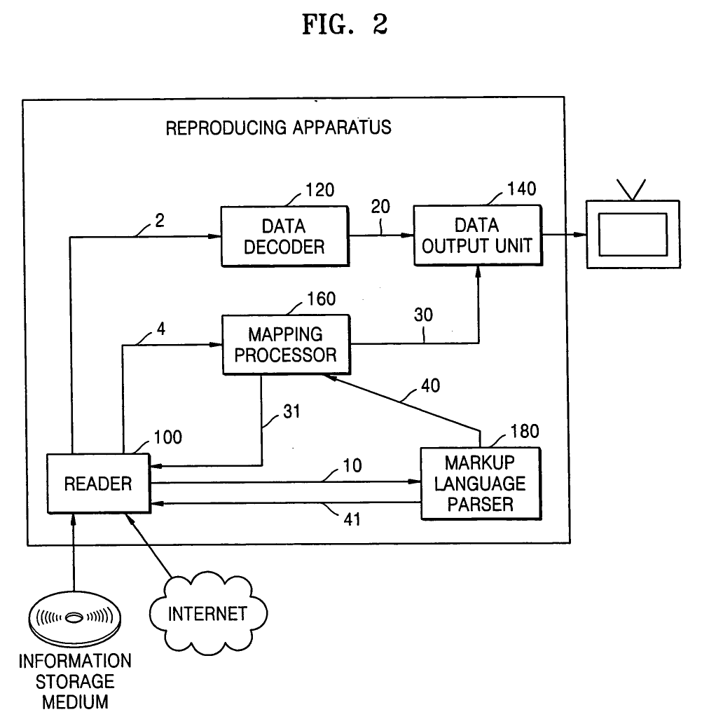

FIG. 2 is a schematic block diagram of a reproducing apparatus according to an embodiment of the present invention. The apparatus of FIG. 2 includes a reader 100, a data decoder 120, a data output unit 140, a mapping processor 160, and a markup language parser 180.

The reader 100 reads video object data and audio data 2 and various data required for reproduction of the video object data and audio data 2 from an information storage medium or from a source external of the information storage medium such as via the Internet.

The data decoder 120 decodes the video object data and audio data 2 read by the reader 100.

The data output unit 140 outputs video object data and audio data 20 decoded by the data decoder 120.

The mapping processor 160 processes audio mapping data 4 and provides the reader 100 with a command 31 that instructs the audio data 2 to be read by the reader 100, and sends the data output unit 140 the audio mapping data 30 that defines the relationship between the video object data and audio data 2. In general, audio data must be mapped to video object data so that it can be reproduced with the audio data. In a conventional DVD, video object data and audio data are multiplexed and recorded in a file such that they have one to one correspondence. Also, reproduction of audio data obtained from the source external of the information storage medium such as the Internet with video object data stored in an information storage medium, requires information regarding a mapping relation between the audio data and the video object data. The present invention adopts audio mapping data that represents the mapping relation between video object data and audio data. The audio mapping data may be either stored in the information storage medium containing the video object data or distributed via the Internet after manufacture of the information storage medium.

If the audio mapping data 10 read by the reader 100 is made in a format of a markup language document, the markup language parser 180 parses it, and sends information 41 regarding the address of the audio mapping data 4 to the reader 100 or sends mapping information 40 to the mapping processor 160. The markup language document generally names documents that are linked to a source made in a markup language or to which such a source is inserted, such as a HyperText Markup Language (HTML) and an eXtensible Markup Language (XML), a script language, and a Java language. Further, the markup language document includes a file linked to a document made in a markup language.

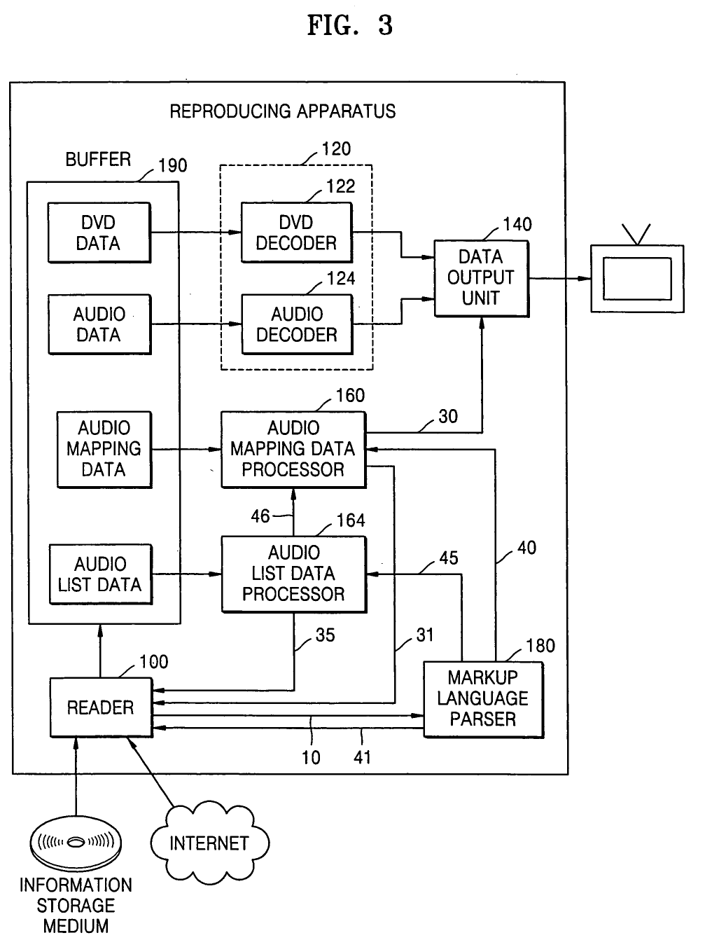

FIG. 3 is a detailed block diagram of the reproducing apparatus of FIG. 2. Referring to FIG. 3, data read by the reader 100 includes video object data, audio data, audio mapping data, audio list data, and a markup language document. In FIG. 3, DVD data is illustrated as the video object data for convenience. The DVD data is stored in a DVD in a particular format.

Data read by the reader 100 is classified according to types and temporarily stored in a buffer 190. As described above, the mapping processor 160 processes audio mapping data 4. In particular, the audio list data is processed by an audio list data processor 164 to provide a menu from which a user can select a desired language in which audio is reproduced.

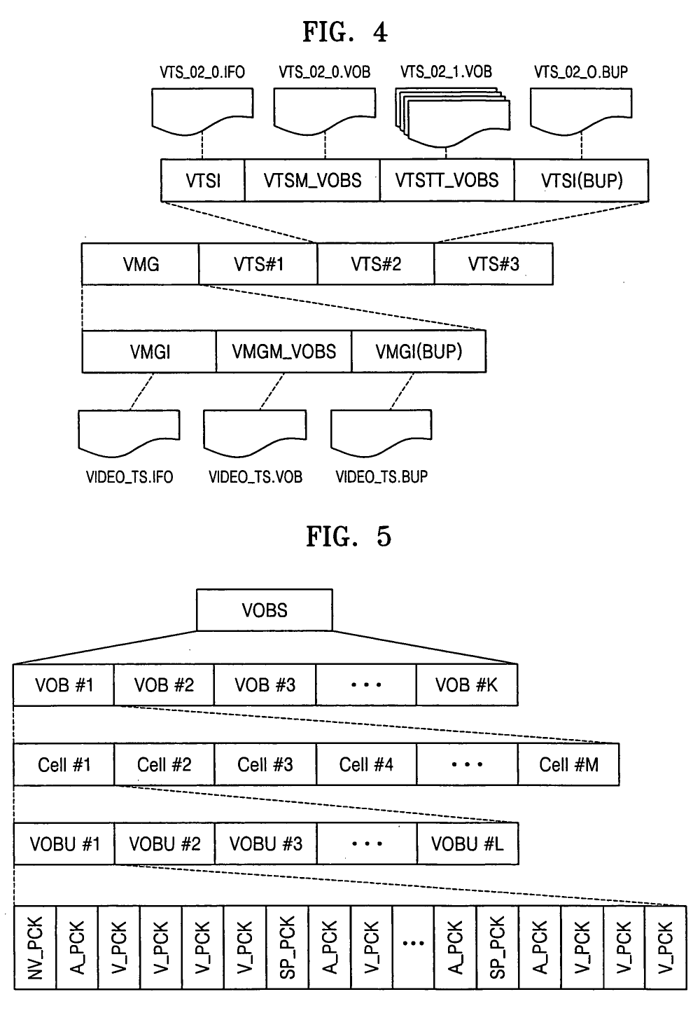

FIG. 4 illustrates a logical structure of a DVD directory. Referring to FIG. 4, a DVD stores a Video ManaGer (VMG) containing header information regarding all video titles, and three Video Title Set (VTS) VTS #1, #2, and #3. The VMG includes a Video ManaGer Information (VMGI) containing control data, a Video Object Set (VMGM_VOBS) area for a video manage menu that is linked to the VMG, and a VMGI BackUP (BUP). The VMGM_VOBS area may not be included in the VMG. The VTS area includes a Video Title Set Information (VTSI) containing the header information, a VOBS (VTSM_VOBS) for displaying a menu screen, a VTSTT_VOBS constituting a video title, and backup data of the VTSI area. Inclusion of the VTSM_VOBS in the VTS area is optional.

FIG. 5 illustrates a logical structure of a video object set. Each of video OBject Sets (VOBSs) constituting video data includes K VOBs. A VOB has M cells. Each cell has L Video Object Units (VOBUs). Each VOBU includes a navigation pack NV_PCK required to reproduce or search for a VOBU. Also, an audio pack A_PCK, a video pack V_PCK, and a sub picture pack SP_PCK are multiplexed and recorded in the VOBU according to the ISO-13818 Motion Picture Expert Group (MPEG).

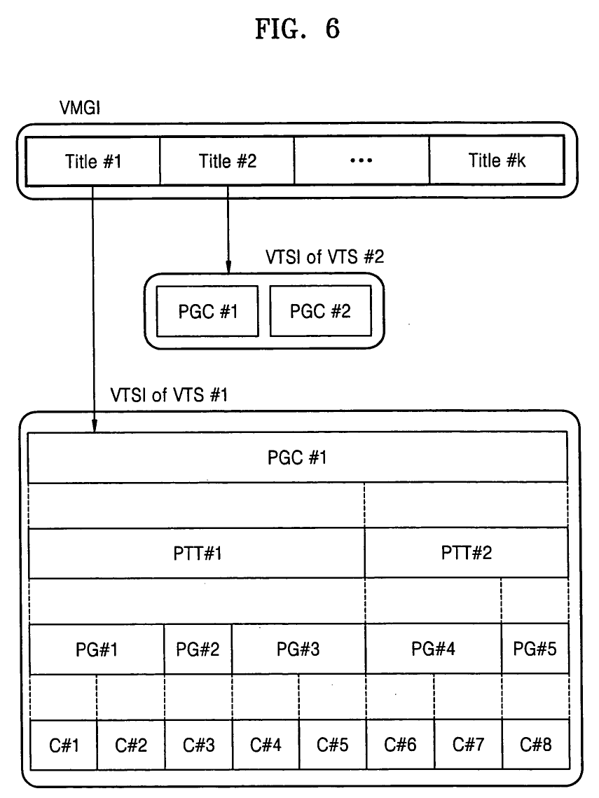

FIG. 6 illustrates structures of VMGI and VTSI. Referring to FIG. 6, the VMGI and the VTSI contain user access information regarding a title, a chapter, or a Part-of-Title (PTT) of information stored in a DVD, and reproduction information for presentation thereof. The VMGI and the VTSI allow a user to access a desired title and a chapter or a PTT of the accessed title. To reproduce the accessed title, a reproducing apparatus detects a ProGram Chain (PGC) and a ProGram (PG), which are reproduction units, and detects and reproduces a cell linked to the PGC or PG. When reproducing respective cells that correspond to cells that are logical units in which information is stored in the DVD, VOBUs indicated by the cells that are logical units are reproduced.

Audio data may be read via the Internet at a time or read when corresponding video object data is reproduced using an audio streaming service.

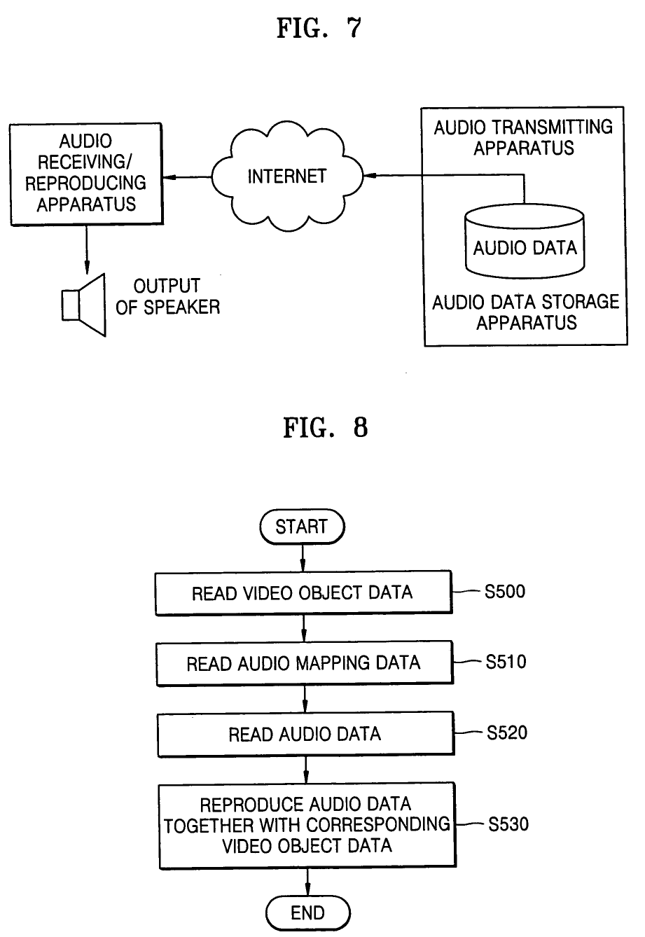

FIG. 7 is a diagram of Internet audio streaming. Internet audio streaming services that transmit audio data via the Internet have been developed. The audio streaming services allow a user to download audio data via the Internet and evaluate a piece of music.

FIG. 8 is a flowchart illustrating a method of reproducing information according to an embodiment of the present invention. Referring to FIG. 8, video object data is read from an information storage medium to reproduce the video object data together with audio data obtained via the Internet (S500). Next, audio mapping data is read (S510). The audio data mapped to the read video object data is read via the Internet based on the audio mapping data (S520). Next, the video object data is reproduced together with the corresponding audio data (S530). The sequence of S500 and S510 may be switched and the read audio mapping data is applicable to a plurality of other video object data. If audio data is read through an audio streaming service, S520 and S530 can be simultaneously performed.

The audio mapping data may be read from the information storage medium, from another information storage medium, from a remote location, from another source, or via the Internet. The sources where the audio mapping data is read from are not limited to those described above and may encompass a plurality of other sources.

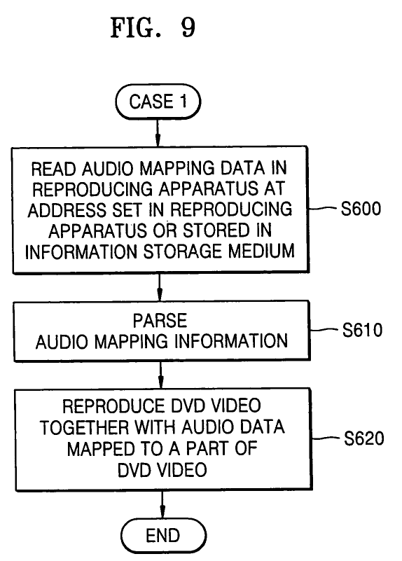

FIG. 9 is a flowchart illustrating a method of reproducing audio mapping data obtained via the Internet according to an embodiment of the present invention. Referring to FIG. 9, audio mapping data is read from an address set in a reproducing apparatus or stored in an information storage medium (S600). Next, the read audio mapping data is parsed (S610). Next, DVD video is reproduced together with audio data mapped to a part of the DVD video being reproduced, based on a result of parsing the audio mapping data (S620). The address of the audio mapping data is input directly from a user or has been read from the information storage medium.

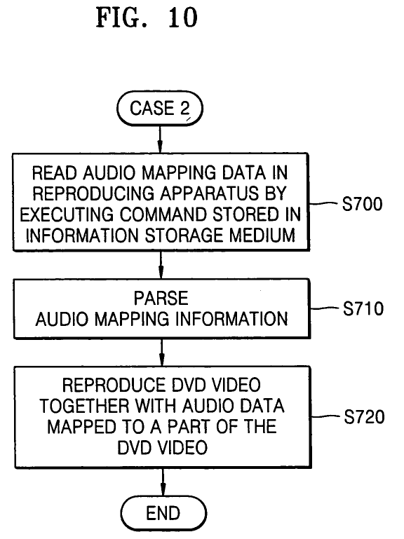

FIG. 10 is a flowchart illustrating a method of reading audio mapping data by executing a command recorded in an information storage medium. Predetermined commands may be stored in a format of a markup language document in the information storage medium. The reproducing apparatus reads the markup language document, parses it using the markup language parser 180 of FIG. 2, and executes the command included in the markup language document. The command is made in a format such as “LoadAudioMap(url)”, and executed to read audio mapping data recorded at an address of a site on the Internet, indicated by the parameter “url” (S700). Then, the read audio mapping data is parsed (S710), and DVD video is reproduced together with audio data mapped to a part of the DVD video being reproduced (S720).

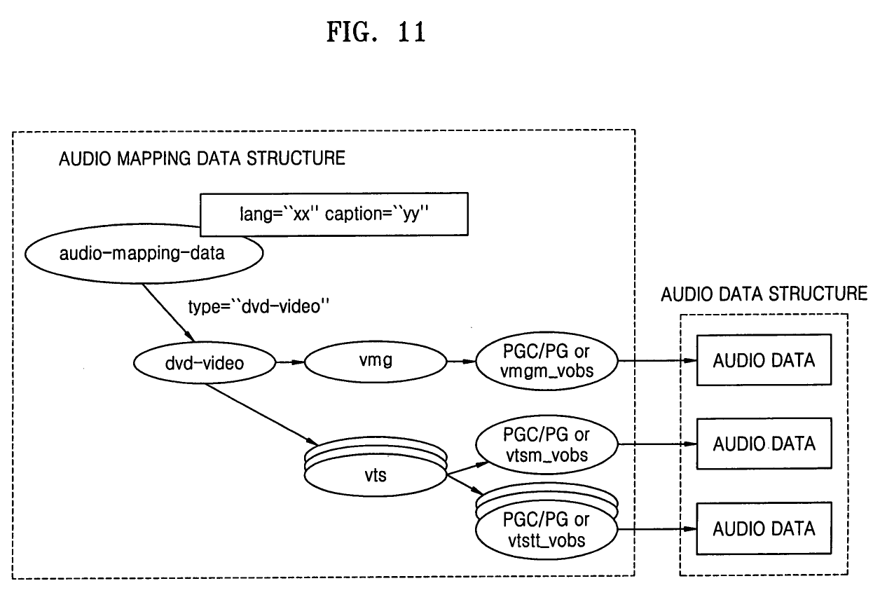

FIG. 11 is a diagram of a structure of audio mapping data according to an embodiment of the present invention. Referring to FIG. 11, the audio mapping data contains information regarding a language and application of the audio data, in addition to information regarding the corresponding audio data and video object data. As shown in FIG. 4, DVD-video has a VMG and a plurality of VTSs. The VMG includes a VMGM_VOBS, and the VTS includes a VTSM_VOBS and a plurality of VTSTT_VOBS. Each VOBS includes a group of cells that are logical units in which information is recorded in an information storage medium. The audio mapping data of FIG. 11 maps the respective VOBSs that are groups of cells to respective audio data. The audio mapping data can allow the audio data to be linked to the respective groups of cells or the respective cells. According to the present invention, an audio data structure maps the respective VOBSs directly to audio data as shown in FIG. 11 or maps the respective VOBSs to audio Meta data that specifies locations and types of the respective audio data.

The audio mapping data is either a markup language or an XML. For instance, a part of the audio mapping data of FIG. 11 can be described in the XML format as follows:

<audio-mapping-data type=dvd-video lang=xx caption=yy>
<dvd-video>
<vmg>
<vmgm_vobs>
<audio vob_idn=1 href=http://movie_audio.com/a.acp />
</vmgm_vobs>
</vmg>
<vts>
<vts idn=1>
<vtsm_vobs>
<audio vob_idn=1 href=http://movie_audio.com/b.acp />
</vtsm_vobs>
</vts>
</dvd-video>
</audio-mapping-data>

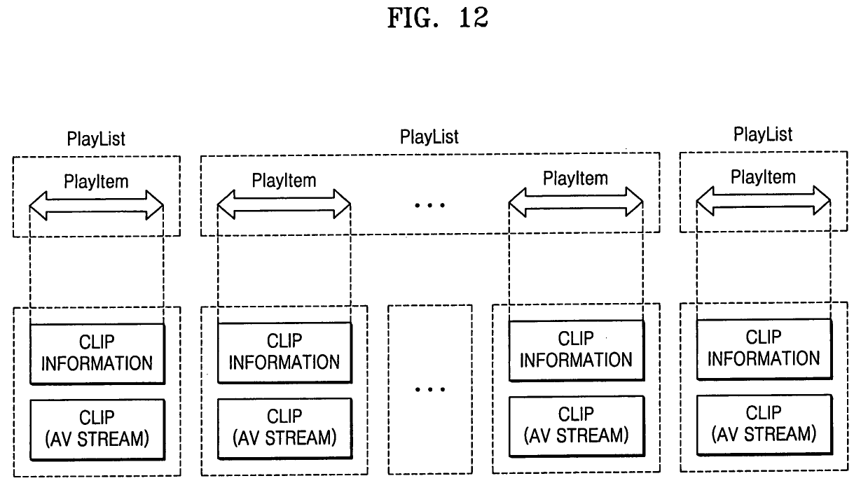

Video object data may be stored in cell units or video clip units. FIG. 12 illustrates a structure of video object data stored in units of video clips. A video clip is a recording unit in which video object data is continuously recorded in the same area. The video clip is stored in a format of an Audio/Video (AV) stream obtained by compressing video object data. To reproduce the AV stream, information regarding characteristics of the compressed video object data is recorded as clip information with the video clip. The clip information specifies the attributes of video object data of the respective clips and includes an entry point map that describes the location of an entry point allowing random access in predetermined units. In the case of an MPEG standard that is mainly used to compress moving images, the entry point becomes the location of an I picture where compression of an intra image starts, and the entry point map is mainly used for time-based search that detects the position of data in a time zone a predetermined length of time after starting of data reproduction. When video object data is stored in units of video clips, there is a need of reproducing audio data corresponding to a part of the video object data.

FIG. 12 illustrates structures of PlayLists and PlayItems that are reproduction units of video object data stored in units of clips. The PlayList is a basic reproduction unit. A plurality of PlayLists are stored in an information storage medium. Each PlayList is linked to a plurality of PlayItems. A PlayItem corresponds to the entire clip or a part thereof and indicates starting and finishing times of reproduction of the clip. Accordingly, when reproducing a PlayList, a plurality of clips may be continuously reproduced or a part of a clip may be reproduced. When audio data is mapped to the PlayList, the audio data can be reproduced with the part of the clip or the plurality of clips linked to the PlayList.

Audio mapping data that maps audio data to video object data in units of PlayLists may be described in the XML format as follow:

<audio-mapping-data type=dvd-video lang=xx caption=yy>
<dvd-video>
<audio playlist=1 playitem=1 href=http://movie.com/c.acp />
<audio playlist=1 playitem=1-9 href=http://movie.com/d.acp />
</dvd-video>
</audio-mapping-data>

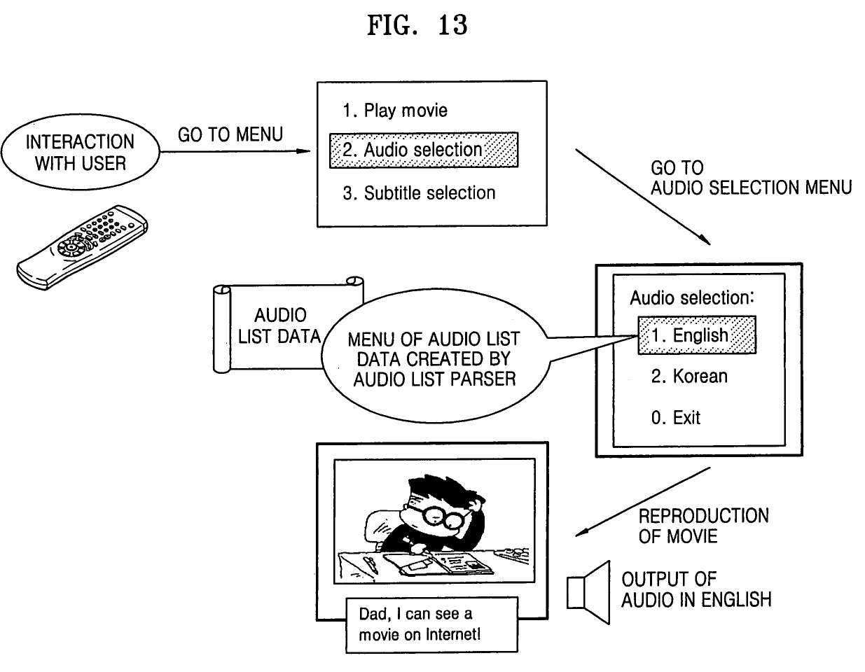

FIG. 13 is a diagram illustrating a method allowing a user to select audio data from an audio list according to a desired language and application of the audio data, and reproduce the audio data with video object data. More specifically, when respective video object data corresponds to a plurality of audio data recorded in languages of various countries, the method enables the user to select audio data recorded in a desired language. Also, when the user views a movie, the method allows the user to determine whether he/she will listen to the audio of the movie or a director's commentary audio regarding the making of the movie while reproducing a moving image.

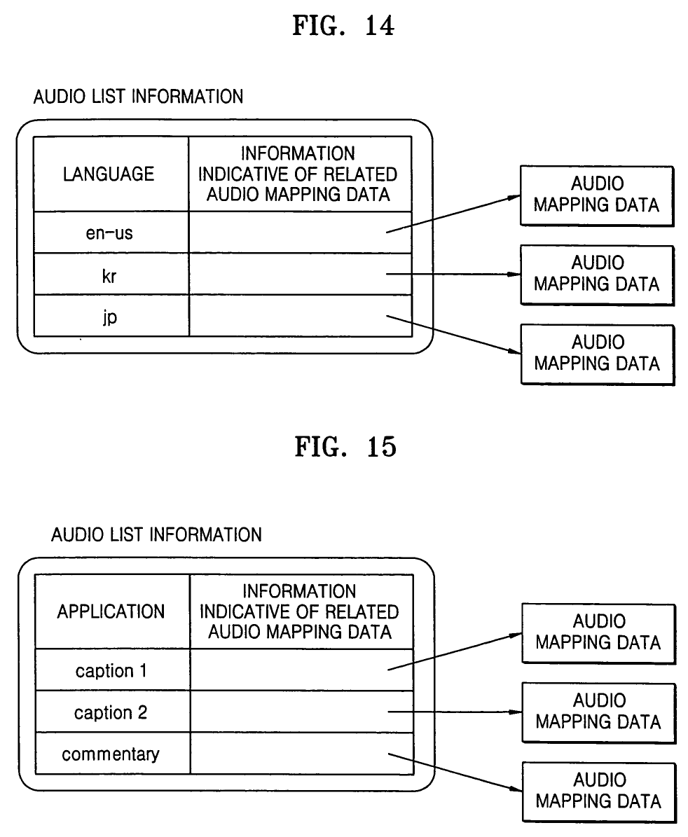

FIG. 14 illustrates a data structure of an audio list allowing a user to select a language in which audio data will be reproduced according to an embodiment of the present invention. The audio list lists the addresses of respective audio mapping data that are classified by the types of languages. Thus, when the user selects a language, a reproducing apparatus is capable of reading audio mapping data corresponding to the selected language.

FIG. 15 illustrates a data structure of an audio list allowing a user to select audio data according to an application, according to an embodiment of the present invention. For instance, the audio list is configured such that the user can select one of audio of dialogues of a movie or commentary audio and can access audio mapping data for the selected application.

Use of the audio list makes it possible to reproduce audio data recorded in languages of various countries and provide a user with audio tracks classified according to various applications.

The audio list may be recorded in a markup language in an information storage medium, and parsed and executed by a markup language parser 180 of FIG. 3.

According to the present invention, it is possible to map audio data obtained via the Internet to video object data stored in the information storage medium and reproduce the audio data with the video object data, using audio mapping data. Also, use of an audio list allows a user to select audio data according to a language and application of the audio data. Accordingly, it is possible to provide the user with audio data that is not recorded in the information storage medium, and further, allow the user to select one of audio data described in languages of various countries according to various applications.

Although a few embodiments of the present invention have been shown and described, it would be appreciated by those skilled in the art that changes may be made in these embodiments without departing from the principles and spirit of the invention, the scope of which is defined in the claims and their equivalents.

1. An information storage medium comprising:
video object data; and
audio mapping data specifying a mapping relation between the video object data and audio data that is obtained from a source external of the information storage medium,
wherein the audio data is reproduced with a corresponding part of the video object data based on the audio mapping data.

2. The information storage medium of claim 1, wherein the video object data is stored in a plurality of cell units that are logical units in which information is stored in the information storage medium, and
the audio mapping data allows the audio data to correspond to the video object data stored in the cell units.

3. The information storage medium of claim 1, wherein the video object data is stored in a plurality of cell units that are logical units in which information is stored in the information storage medium, and
the audio mapping data allows the audio data to correspond to the video object data in groups of cells units.

4. The information storage medium of claim 1, wherein the video object data is stored in units of video clips, and
the audio mapping data allows the audio data to correspond to the video object data stored in the units of video clips.

5. The information storage medium of claim 1, wherein the video object data is stored in units of video clips, and
the audio mapping data allows the audio data to be mapped to a part of a clip of the video object data.

6. The information storage medium of claim 1, wherein the video object data is stored in units of video clips, and
the audio mapping data allows the audio data to be mapped to a playlist corresponding to a part of a clip or a plurality of clips of the video object data.

7. The information storage medium of claim 1, wherein the audio mapping data specifies the video object data and an address of a site on the source external of the information storage medium in which corresponding audio data is stored, using a markup language.

8. A reproducing apparatus comprising:
a reader reading video object data from an information storage medium, audio data from a source external of the information storage medium, and audio mapping data;
a mapping processor processing mapping data regarding a mapping relationship between the video object data and the audio data, and providing a relationship between the audio data and the video object data, the mapping data being included in the audio mapping data;
a decoder decoding the video object data and the audio data; and
a data output unit outputting the decoded video object data with the decoded audio data, based on the audio mapping data.

9. The reproducing apparatus of claim 8, wherein the reader reads the audio mapping data from the source external of the information storage medium, using an address of the audio mapping data input by a user.

10. The reproducing apparatus of claim 8, wherein the reader reads the audio mapping data from a source external of the information storage medium, using an address of the audio mapping data stored in the information storage medium.

11. The reproducing apparatus of claim 8, wherein the reader further reads a markup language document from the information storage medium,
the reproducing apparatus further comprising a markup language parser parsing a command defined in the markup language document, providing an address of the audio mapping data to the reader, or providing the audio mapping data to the mapping processor.

12. The reproducing apparatus of claim 8, wherein the reader reads the audio mapping data from the information storage medium.

13. A method of reproducing information, comprising:
reading video object data from an information storage medium;
reading audio mapping data that specifies a mapping relationship between the video object data and audio data obtained from the source external of the information storage medium;
reading the audio data mapped to the video object data from a source external of the information storage medium, based on the audio mapping data; and
reproducing the video object data with the mapped audio data based on the audio mapping data.

14. The method of claim 13, wherein during the reading of the audio mapping data, the audio mapping data is read from the source external of the information storage medium, using an address of the audio mapping data input by a user.

15. The method of claim 13, wherein during the reading of the audio mapping data, the audio mapping data is read from the source external of the information storage medium, using an address of the audio mapping data stored in the information storage medium.

16. The method of claim 13, wherein the reading of the audio mapping data comprises:
reading a markup language document from the information storage medium; and
reading the audio mapping data by executing a command defined in the markup language document.

17. The method of claim 13, wherein the reading of the audio mapping data comprises:
reading information regarding audio lists including a plurality of option items from the source external of the information storage medium, and allowing a user to select one of the audio lists;
reading the audio mapping data corresponding to the selected one of the audio lists.

18. The method of claim 17, wherein during the reading of the information, the user is allowed to select an audio list corresponding to audio data in a desired language from the audio lists classified according to a plurality of languages of audio data;
during the reading of the audio mapping data, the audio mapping data corresponding to a selected language is read; and
during the reading of the audio data mapped to the video object data, the audio data recorded in the selected language is read.

19. The method of claim 17, wherein during the reading of the information regarding the audio lists, the user is allowed to select an audio list of a desired application from the audio lists classified according to applications of audio data,
during the reading of the audio mapping data corresponding to the selected one of the audio lists, the audio mapping data corresponding to a selected application is read, and
during the reading of the audio data mapped to the video object data, the audio data corresponding to the selected application is read.

20. The method of claim 19, wherein during the reading of the information regarding the audio lists, the user selects whether to listen to the audio data corresponding to the video object data or the audio data containing a commentary of a manufacturer of the video object data, during reproduction of the video object data.

21. The method of claim 17, wherein the reading of the information regarding the audio lists comprises:
reading a markup language document from the information storage medium; and
reading the audio lists by executing a command defined in the markup language document.

22. The method of claim 13, wherein the audio data is audio stream data read using an audio streaming service, and
the reading of the audio data mapped to the video object data and the reproducing the video object data are simultaneously performed.

23. The method of claim 13, wherein during the reading of the audio mapping data, the audio mapping data is read from the information storage medium.

24. The information storage medium of claim 1, wherein the source external of the information storage medium is the Internet.

25. The apparatus of claim 8, wherein the source external of the information storage medium is the Internet.

26. The method of claim 13, wherein the source external of the information storage medium is the Internet.

27. A method of reproducing information, comprising:
mapping audio data, obtained from a remote location, to video object data stored in an information storage medium; and
reproducing the audio data with the video object data, using audio mapping data.

28. The method of claim 27, wherein the audio mapping data is stored in the information storage medium containing the video object data.

29. The method of claim 27, wherein the audio mapping data is distributed via Internet after the information storage medium has been manufactured.

30. The method of claim 27, wherein the remote location where the mapping audio data is obtained from is the Internet.

31. A reproducing apparatus, comprising:
a reader reading data from an information storage medium and from a remote location, and outputting video object data, audio data and mapping data;
a mapping processor processing the mapping data and outputting audio mapping data;
a decoder decoding the video object data and the audio data; and
a data output unit reproducing the audio data with the video object data, using the output mapping data.

32. The apparatus of claim 31, wherein the reader reads the mapping data using an address input by a user.

33. The apparatus of claim 31, wherein the reader reads the mapping data using an address stored in the information storage medium.

34. The apparatus of claim 31, further comprising a markup language parser parsing a command defined in a markup language document from the information storage medium, and provides an address of the mapping data to the reader.

35. The apparatus of claim 31, further comprising a markup language parser parsing a command defined in a markup language document from the information storage medium, and provides the mapping data to the mapping processor.

36. The apparatus of claim 31, wherein the remote location where the data is read from is the Internet.
